(19) United States
(12) Patent Application Publication
(10) Pub. No.: US 2026/0302962 A1
(43) Pub. Date: Oct. 1, 2026

(54) DCDC CONVERTER CONTROL METHOD, CONTROLLER, CONTROL DEVICE AND MEDIUM

(71) Applicant: Delta Electronics (Shanghai) Co., Ltd., Shanghai (CN)

(72) Inventors: Zhiyong CHEN, Shanghai (CN); Fangjun DU, Shanghai (CN); Xiangwei YAN, Shanghai (CN); Peng ZHU, Shanghai (CN)

(21) Appl. No.: 19/574,449

(22) Filed: Mar. 23, 2026

(30) Foreign Application Priority Data
Mar. 25, 2025 (CN) 202510363609.3

(51) Int. Cl. H02M 3/335

(52) U.S. Cl. CPC H02M 3/33592; H02M 3/33573

(57) ABSTRACT

Embodiments of the present application provide a DCDC converter control method, a controller, a control device and a medium. An output voltage of a high-voltage side of a DCDC converter and an input current of a low-voltage side of the DCDC converter are obtained. A voltage loop output signal is outputted according to the output voltage and a reference voltage, and a current loop output signal is outputted according to the input current and a reference current. Then a control signal of a synchronous rectification switch is determined according to the voltage loop output signal, the current loop output signal, and a duty cycle limiting signal of the synchronous rectification switch. Correspondingly, on-time of a clamping switch can be controlled based on the control signal of the synchronous rectification switch and an operation state of the DCDC converter.

### CROSS-REFERENCE TO RELATED APPLICATION

The present application claims priority to Chinese Patent Application No. 202510363609.3, filed with China National Intellectual Property Administration on Mar. 25, 2025 and entitled “DCDC CONVERTER CONTROL METHOD, CONTROLLER, CONTROL DEVICE AND MEDIUM”. The disclosure of the aforementioned application is hereby incorporated by reference in its entirety.

### TECHNICAL FIELD

The present disclosure relates to the field of converters and, in particular, to a DCDC converter control method, a controller, a control device and a medium.

### BACKGROUND

Reverse pre-charging refers to a gradual increase of voltage from a low-voltage side to a high-voltage side during start-up of a direct current-direct current (Direct-Direct, DCDC) converter, to avoid an impact of instantaneous high current on circuit components and improve the safety and reliability of the converter.

Currently, the reverse pre-charging of the DCDC converter can be achieved by an active clamping circuit. The clamping circuit can be used to limit the maximum values of voltage and current to prevent them from exceeding predetermined safety thresholds, while acting as an energy transfer intermediary.

The control of switching devices in the clamping circuit determines the limitation and regulation ability of voltage and current. How to control the switching devices in the clamping circuit is an important issue.

### SUMMARY

Embodiments of the present application provide a DCDC converter control method, a controller, a control device and a medium.

In a first aspect, embodiments of the present application provide a DCDC converter control method, where a DCDC converter includes a synchronous rectification switch and a clamping switch, and the method includes:
obtaining an output voltage of a high-voltage side of the DCDC converter and an input current of a low-voltage side of the DCDC converter;
outputting a voltage loop output signal according to the output voltage and a reference voltage, and outputting a current loop output signal according to the input current and a reference current;
determining a control signal of the synchronous rectification switch according to the voltage loop output signal, the current loop output signal, and a duty cycle limiting signal of the synchronous rectification switch; and
controlling on-time of the clamping switch based on the control signal of the synchronous rectification switch and an operation state of the DCDC converter.

In a second aspect, the present application provides a controller, including: a proportional-integral controller, a comparator and a pulse signal generator, where the comparator is connected to the proportional-integral controller and the pulse signal generator;
the proportional-integral controller is configured to: output a voltage loop output signal according to the output voltage and a reference voltage, and output a current loop output signal according to the input current and a reference current;
the comparator is configured to determine a control signal of a synchronous rectification switch in the DCDC converter according to the voltage loop output signal, the current loop output signal, and a duty cycle limiting signal of the synchronous rectification switch in the DCDC converter;
the pulse signal generator is configured to control on-time of a clamping switch in the DCDC converter based on the control signal of the synchronous rectification switch and an operation state of the DCDC converter.

In a third aspect, the present application provides a control device, including: the controller according to the second aspect and a DCDC converter, where the DCDC converter includes a synchronous rectification switch and a clamping switch;
the controller is configured to control on-time of the clamping switch based on a control signal of the synchronous rectification switch and an operation state of the DCDC converter.

In a fourth aspect, embodiments of the present application provide a non-transitory computer-readable storage medium, where the computer-readable storage medium stores computer instructions therein, and when the computer instructions are executed by a processor, the method according to the first aspect as described above is implemented.

In a fifth aspect, embodiments of the present application provide a computer program product, where the computer program product includes a non-transitory computer program, and when the computer program is executed by a processor, the method according to the first aspect as described above is implemented.

### BRIEF DESCRIPTION OF DRAWINGS

The accompanying drawings, which are incorporated into the specification and form a part of the specification, illustrate embodiments in accordance with the present application and are used together with the specification to explain the principles of the present application.

FIG. 1 is a schematic circuit diagram of a DCDC converter provided in the present application.

FIG. 2 is an operation timing diagram of a DCDC converter provided in the present application.

FIG. 3 and FIG. 4 are schematic operation diagrams of a DCDC converter provided in the present application.

FIG. 5 is another operation timing diagram of a DCDC converter provided in the present application.

FIG. 6 is a schematic operation diagram of a DCDC converter provided in the present application.

FIG. 7 is a schematic circuit diagram of a DCDC converter provided in the present application.

FIG. 8 is yet another operation timing diagram of a DCDC converter provided in the present application.

FIG. 9-FIG. 13 are schematic operation diagrams of a DCDC converter provided in the present application.

FIG. 14 is yet another operation timing diagram of a DCDC converter provided in the present application.

FIG. 15-FIG. 19 are schematic operation diagrams of a DCDC converter provided in the present application.

FIG. 20 is an operation timing diagram of a clamping switch provided in the present application.

FIG. 21 is a schematic diagram of charging and discharging of a clamping capacitor provided in the present application.

FIG. 22 is another operation timing diagram of a clamping switch provided in the present application.

FIG. 23 is a schematic diagram of charging and discharging of a clamping capacitor provided in the present application.

FIG. 24 is yet another operation timing diagram of a DCDC converter provided in the present application.

FIG. 25-FIG. 29 are schematic operation diagrams of a DCDC converter provided in the present application.

FIG. 30 is yet another operation timing diagram of a DCDC converter provided in the present application.

FIG. 31-FIG. 35 are schematic operation diagrams of a DCDC converter provided in the present application.

FIG. 36 is yet another operation timing diagram of a clamping switch provided in the present application.

FIG. 37 is a curve diagram of discharge efficiency provided in the present application.

FIG. 38 is yet another operation timing diagram of a clamping switch provided in the present application.

FIG. 39 is a schematic diagram of discharge efficiency provided in the present application.

FIG. 40 is a schematic flowchart of a DCDC converter control method provided in the present application.

FIG. 41 is a schematic structural diagram of a controller provided in the present application.

FIG. 42 is a schematic structural diagram of a control device provided in the present application.

Through the above accompanying drawings, explicit embodiments of the present application have been shown, and more detailed descriptions will be provided in the following. These accompanying drawings and textual descriptions are not intended to limit the scope of the concept of the present application in any way, but rather to illustrate the concept of the present application for those skilled in the art by referring to the specific embodiments.

### DETAILED DESCRIPTION OF EMBODIMENTS

Exemplary embodiments will be described in detail herein, with examples shown in the accompanying drawings. When the following description refers to the accompanying drawings, unless otherwise indicated, the same numbers in different drawings represent the same or similar elements. The implementations described in the following exemplary embodiments do not represent all embodiments consistent with the present application. On the contrary, they are only examples of apparatuses and methods consistent with some aspects of the present application as described in the appended claims.

As shown in FIG. 1, a DCDC converter includes an inverter module 101, a transformer module 102 and a rectifier module 103. The inverter module 101 includes a first end, a second end, a third end and a fourth end. The transformer module 102 includes a first end, a second end, a third end, a fourth end and a fifth end. The rectifier module 103 includes a first end, a second end, a third end, a fourth end and a fifth end.

The first end and the second end of the inverter module 101 are connected to a high-voltage side HV of the DCDC converter. The third end and the fourth end of the inverter module 101 are respectively connected to the first end and the second end of the transformer module 102. The third end, the fourth end and the fifth end of the transformer module 102 are respectively connected to the first end, the second end and the third end of the rectifier module 103. The fourth end and the fifth end of the rectifier module 103 are connected to a low-voltage side LV of the DCDC converter.

The inverter module 101 may be used to convert power from batteries, solar panels or other DC power sources to AC power; the transformer module 102 is used to reduce or increase the voltage of the AC power outputted from the inverter module 101; and the rectifier module 103 is used to convert the AC power outputted from the transformer module 102 back to DC power to supply power to DC loads, or to charge batteries or energy storage devices.

Exemplarily, the inverter module 101 includes a first bridge arm and a second bridge arm. The first bridge arm includes a first switch Q1 and a second switch Q2, and the second bridge arm includes a third switch Q3 and a fourth switch Q4.

A first end of the first switch Q1 is connected to a first end of the third switch Q3 to serve as the first end of the inverter module 101 to connect to a positive electrode of the high-voltage side HV; a second end of the second switch Q2 is connected to a second end of the fourth switch Q4 to serve as the second end of the inverter module 101 to connect to a negative electrode of the high-voltage side HV; a second end of the first switch Q1 is connected to a first end of the second switch Q2 to serve as the third end of the inverter module 101 to connect to the first end of the transformer module 102; a second end of the third switch Q3 is connected to a first end of the fourth switch Q4 to serve as the fourth end of the inverter module 101 to connect to the second end of the transformer module 102.

For example, the first switch Q1 to the fourth switch Q4 may be N-type MOSFETs (Metal Oxide Semiconductor Field Effect Transistors), with the drain of the N-type MOSFET being the first end of the switch and the source of the N-type MOSFET being the second end of the switch.

Exemplarily, an input capacitor C2 may be connected between the first end and the second end of the inverter module 101. The input capacitor C2 can provide a low-impedance current source for providing the current required by the switches. The input capacitor C2 can also store electrical energy and release it when needed to ensure the continuity and stability of the current. The input capacitor C2 can also play a filtering role.

Exemplarily, the transformer module 102 includes a first winding and a second winding.

A first end of the first winding serves as the first end of the transformer module 102 and is connected to the third end of the inverter module 101; a second end of the first winding serves as the second end of the transformer module 102 and is connected to the fourth end of the inverter module 101; a first end of the second winding serves as the third end of the transformer module 102 and is connected to the first end of the rectifier module 103; a second end of the second winding serves as the fourth end of the transformer module 102 and is connected to the second end of the rectifier module 103; a third end of the second winding serves as the fifth end of the transformer module 102 and is connected to the third end of the rectifier module 103.

Here, the second winding may include a first sub-winding and a second sub-winding. A first end of the first sub-winding serves as the first end of the second winding; a second end of the first sub-winding is connected to a first end of the second sub-winding to serve as the third end of the second winding; and a second end of the second sub-winding serves as the second end of the second winding. The turn ratio of the first sub-winding, the second sub-winding and the first winding is 1:1:N, and N may be determined according to an actual situation.

Exemplarily, the rectifier module 103 may include a synchronous rectification (SR) switch, a first inductor Lout and a first capacitor C1, and the synchronous rectification switch may include a first switching device SRA and a second switching device SRB.

A first end of the first switching device SRA serves as the first end of the rectifier module 103 and is connected to the third end of the transformer module 102; a first end of the second switching device SRB serves as the second end of the rectifier module 103 and is connected to the fourth end of the transformer module 102; a second end of the first inductor Lout serves as the third end of the rectifier module 103 and is connected to the fifth end of the transformer module 102; a first end of the first capacitor C1 is connected to a first end of the first inductor Lout to serve as the fourth end of the rectifier module 103 to connect to a positive electrode of the low-voltage side LV; and a second end of the first capacitor C1 serves as the fifth end of the rectifier module 103 and is connected to a negative electrode of the low-voltage side LV.

For example, the first switching device SRA and the second switching device SRB may be N-type MOSFETs, with the drain of the N-type MOSFET being the first end of the switching device and the source of the N-type MOSFET being the second end of the switching device.

In practical applications, the DCDC converter is required to enable reverse pre-charging to avoid an impact of instantaneous high current on circuit components.

For example, in an electric vehicle or a new energy vehicle, high-voltage DC power supplied by a power battery needs to be converted to a voltage suitable for use in a low-voltage system of the vehicle through the DCDC converter. At an initial stage of power-up, if a high-voltage circuit is directly connected, components in the circuit may be damaged due to an excessive current. Reverse pre-charging through the DCDC converter can ensure a smooth transition of the circuit to a normal operation state.

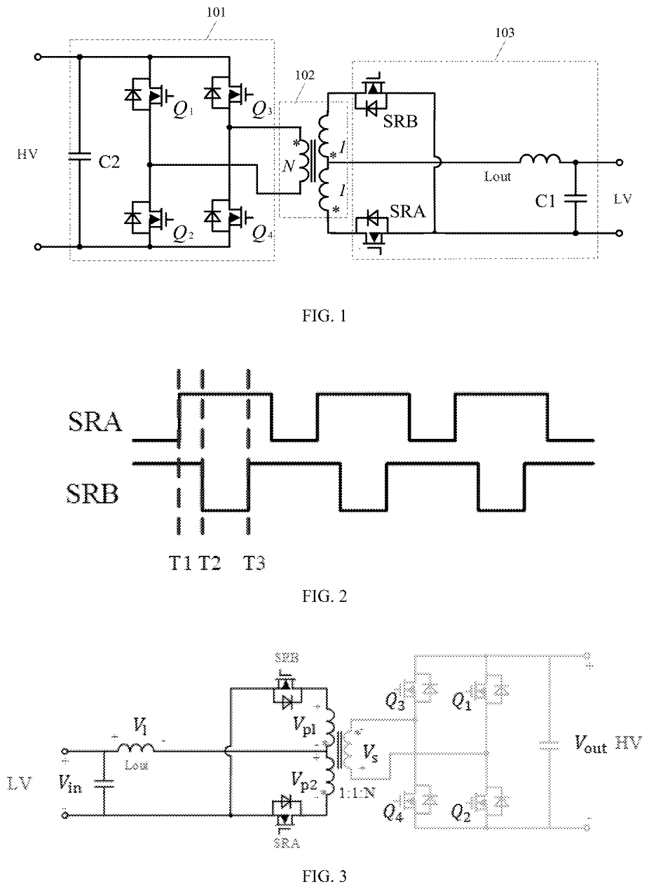

The applicant has found, after research, that in order to be able to boost the voltage, the synchronous rectification switch (e.g., the first switching device SRA and the second switching device SRB) can be operated at a duty cycle (Duty) above 50%. As shown in FIG. 2, both the first switching device SRA and the second switching device SRB are turned on in the stage T1~T2, and in the stage T2~T3 of FIG. 2, the first switching device SRA is turned on and the second switching device SRB is turned off.

Correspondingly, in the stage T1~T2, as shown in FIG. 3, both the first switching device SRA and the second switching device SRB are turned on. At this time:

$${V}_{1} = {V}_{i n} - {V}_{p 2} > 0$$

$${V}_{p 1} = - {V}_{p 2}$$

$${V}_{s} = 0$$

where V₁ is a voltage of the first inductor Lout, Vᵢₙ is a voltage of the low-voltage side LV, Vₚ₂ is a voltage of the second sub-winding, Vₚ₁ is a voltage of the first sub-winding, and Vₛ is a voltage of the first winding.

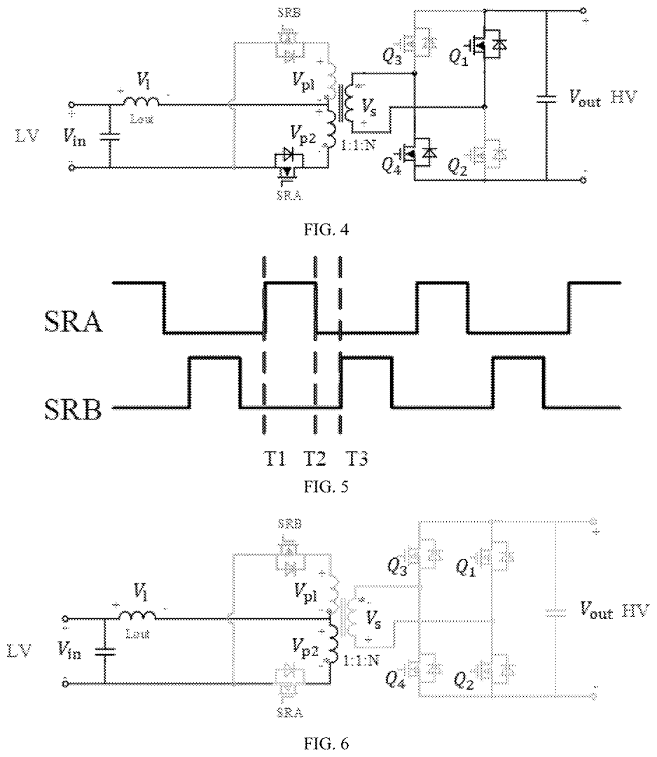

In the stage T2~T3, as shown in FIG. 4, the first switching device SRA is turned on and the second switching device SRB is turned off. At this time:

$${V}_{1} = {V}_{i n} - {V}_{p 2} > 0$$

$${V}_{p 1} = {V}_{p 2} = {V}_{s} / N$$

$${V}_{s} = {V}_{out}$$

where V₁ is the voltage of the first inductor Lout, Vᵢₙ is the voltage of the low-voltage side LV, Vₚ₂ is the voltage of the second sub-winding, Vₚ₁ is the voltage of the first sub-winding, Vₛ is the voltage of the first winding, N is a turn ratio of the first winding to the second sub-winding, and Vₒᵤₜ is a voltage of the high-voltage side HV.

Therefore, when the system or the equipment (e.g. the electric vehicle or the new energy vehicle) starts up, if the synchronous rectification switch is directly operated at a duty cycle of 50%, input energy is stored through the first inductor Lout and also transmitted to the high-voltage side HV. Initially, since the voltage of the high-voltage side HV is very small, and the voltage across the two ends of the first inductor Lout is still a large positive voltage, the first inductor Lout cannot release the energy. This will result in that the current of the first inductor Lout is continuously increased until the voltage of the high-voltage side HV reaches the voltage of the low-voltage side LV multiplied by N (the voltage*N), only after which the first inductor Lout can release the energy. At this time, the current of the first inductor Lout will be very large or even lead to saturation and damage. Here, N can be determined according to an actual situation.

If the synchronous rectification switch is operated at a duty cycle below 50%, as shown in FIG. 5, during the stage T1~T2 in FIG. 5, the first switching device SRA is turned on and the second switching device SRB is turned off, and during the stage T2~T3 in FIG. 5, both the first switching device SRA and the second switching device SRB are turned off.

Correspondingly, in the stage T1~T2, as shown in FIG. 4, the first switching device SRA is turned on and the second switching device SRB is turned off. At this time:

$${V}_{1} = {V}_{i n} - {V}_{p 2} > 0$$

$${V}_{p 1} = {V}_{p 2} = {V}_{s} / N$$

$${V}_{s} = {V}_{out} .$$

In the stage T2~T3, as shown in FIG. 6, both the first switching device SRA and the second switching device SRB are turned off. The current of the first inductor Lout will quickly drop to zero, and the first inductor Lout induces a large voltage, resulting in that the first inductor Lout is subjected to the stress of this voltage and gets damaged.

In summary, common full-bridge, full-wave buck topologies are basically unable to achieve a reverse output.

Embodiments of the present application propose reverse pre-charging of a DCDC converter using an active clamping circuit, where the active clamping circuit is connected in parallel with a synchronous rectification switch. When the DCDC converter is in a forward operation mode (Buck Mode), the active clamping circuit can effectively reduce the voltage stress on the synchronous rectification switch; when the DCDC converter is in a reverse operation mode (Boost Mode), there is no need to add any other device, and the reverse pre-charging can be realized by modifying software without increasing hardware cost.

Exemplarily, the active clamping circuit may include a clamping switch and a clamping capacitor. When the synchronous rectification switch is turned off, the current of the first inductor Lout will drop rapidly, and the first inductor Lout will release energy and generate a spike voltage. The clamping switch can transfer this part of the energy to the clamping capacitor, thereby avoiding a damage to the circuit components caused by the spike voltage.

Exemplarily, the active clamping circuit may further include a clamping diode and a clamping resistor. The clamping resistor is connected between the clamping capacitor and the clamping switch, and the clamping diode is connected in parallel with the clamping switch and the clamping resistor that are connected in series. The clamping capacitor is used to absorb and store energy, and the clamping resistor is used to dissipate that energy. The clamping diode is used to prevent a reverse flow of the current, thereby protecting other components in the circuit.

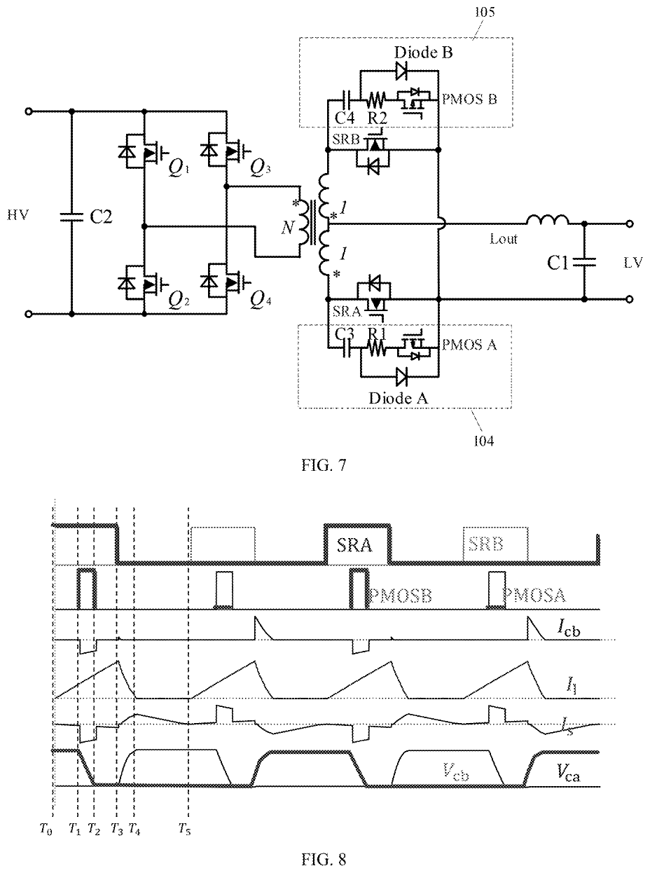

For example, as shown in FIG. 7, a first clamping circuit 104 which is connected in parallel with the first switching device SRA is included, and the first clamping circuit 104 includes a first clamping switch PMOS A, a first clamping capacitor C3, a first clamping resistor R1 and a first clamping diode Diode A.

A first end of the first clamping capacitor C3 is connected to the first end of the first switching device SRA; a second end of the first clamping capacitor C3 is connected to a first end of the first clamping resistor R1; a second end of the first clamping resistor R1 is connected to a first end of the first clamping switch PMOS A; and a second end of the first clamping switch PMOS A is connected to the second end of the first switching device SRA. The anode of the first clamping diode Diode A is connected to the first end of the first clamping resistor R1, and the cathode of the first clamping diode Diode A is connected to the second end of the first clamping switch PMOS A.

As shown in FIG. 7, a second clamping circuit 105 which is connected in parallel with the second switching device SRB is further included, and the second clamping circuit 105 includes a second clamping switch PMOS B, a second clamping capacitor C4, a second clamping resistor R2 and a second clamping diode Diode B.

A first end of the second clamping capacitor C4 is connected to the first end of the second switching device SRB; a second end of the second clamping capacitor C4 is connected to a first end of the second clamping resistor R2; a second end of the second clamping resistor R2 is connected to a first end of the second clamping switch PMOS B; and a second end of the second clamping switch PMOS B is connected to the second end of the second switching device SRB. The anode of the second clamping diode Diode B is connected to the first end of the second clamping resistor R2, and the cathode of the second clamping diode Diode B is connected to the second end of the second clamping switch PMOS B.

For example, the first clamping switch PMOS A and the second clamping switch PMOS B may be P-type MOSFETs, with the drain of the P-type MOSFET being the first end of the switching device, and the source of the P-type MOSFET being the second end of the switching device.

It should be noted that a process of the reverse pre-charging may include a soft start period and a steady state. The soft start period refers to a stage in which a driving duty cycle of the synchronous rectification switch is gradually increased from zero after the DCDC converter starts up. The steady state is a stage which begins immediately after the open loop driving duty cycle of the synchronous rectification switch reaches duty limit value of open loop.

Exemplarily, in the soft start period, the duty cycle of the synchronous rectification switch is slowly increased from a small value (e.g., 5%) and meanwhile the voltage Vₒᵤₜ of the high-voltage side is also slowly increased. The duty cycle of the synchronous rectification switch and the slope of change of the voltage of the high-voltage side can be adjusted according to the voltage Vₒᵤₜ of the high-voltage side.

In the soft start period, the synchronous rectification switch is inevitably operated at the duty cycle below 50%. If the voltage Vₒᵤₜ of the high-voltage side is less than N*the voltage Vᵢₙ of the low-voltage side, and the operation timing of the DCDC converter is as shown in FIG. 8, an example of five stages can be given:
in the stage T0~T1: the first switching device SRA is turned on; the second switching device SRB, the first clamping switch PMOS A, the second clamping switch PMOS B, the first clamping diode Diode A and the second clamping diode Diode B are turned off; as shown in FIG. 9, at this time:

$${V}_{1} = {V}_{i n} - {V}_{p 2} > 0$$

$${V}_{p 1} = {V}_{p 2} = {V}_{s} / N$$

$${V}_{s} = {V}_{out} ;$$

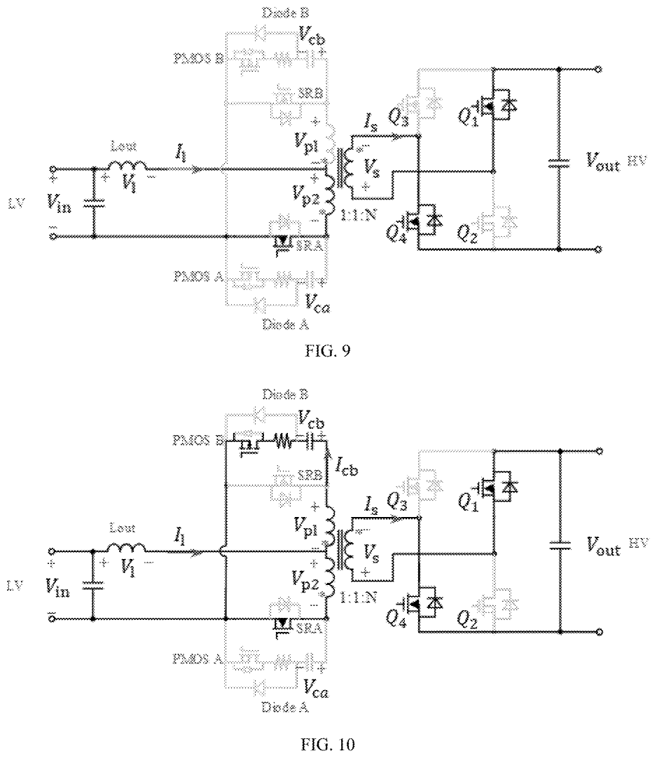

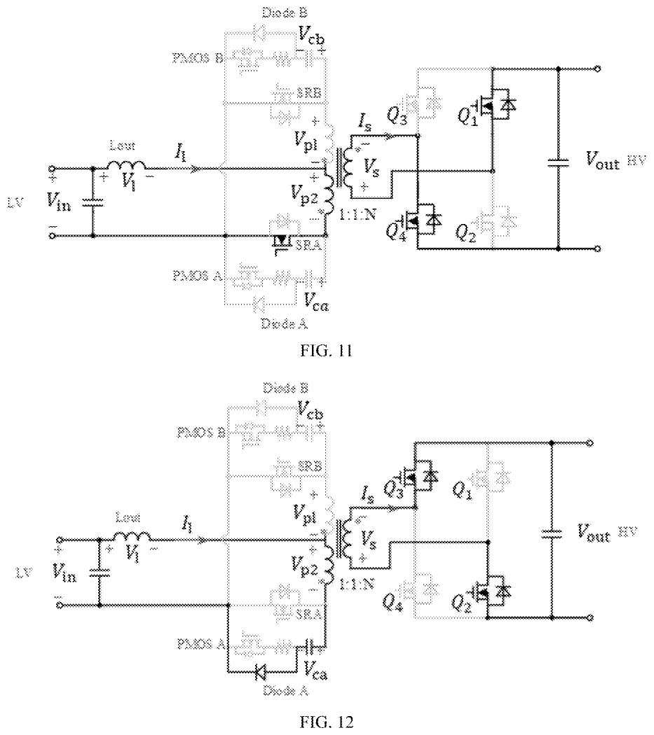

in the stage T1~T2: the first switching device SRA and the second clamping switch PMOS B are turned on; the second switching device SRB, the first clamping switch PMOS A, the first clamping diode Diode A and the second clamping diode Diode B are turned off; as shown in FIG. 10, at this time:

$${V}_{1} = {V}_{i n} - {V}_{p 2} > 0$$

$${V}_{p 1} = {V}_{p 2} = {V}_{s} / N$$

$${V}_{s} = {V}_{out} ;$$

in the stage T2~T3: the first switching device SRA is turned on; the second switching device SRB, the first clamping switch PMOS A, the second clamping switch PMOS B, the first clamping diode Diode A and the second clamping diode Diode B are turned off; as shown in FIG. 11, at this time:

$${V}_{1} = {V}_{i n} - {V}_{p 2} > 0$$

$${V}_{p 1} = {V}_{p 2} = {V}_{s} / N$$

$${V}_{s} = {V}_{out} ;$$

in the stage T3~T4: the first clamping diode Diode A is turned on; the first switching device SRA, the second switching device SRB, the first clamping switch PMOS A, the second clamping switch PMOS B and the second clamping diode Diode B are turned off; as shown in FIG. 12, at this time:

$${V}_{1} = {V}_{i n} - {V}_{p 2} < 0$$

$${V}_{p 1} = {V}_{p 2} = {V}_{s} / N$$

$${V}_{s} = - {V}_{out} ;$$

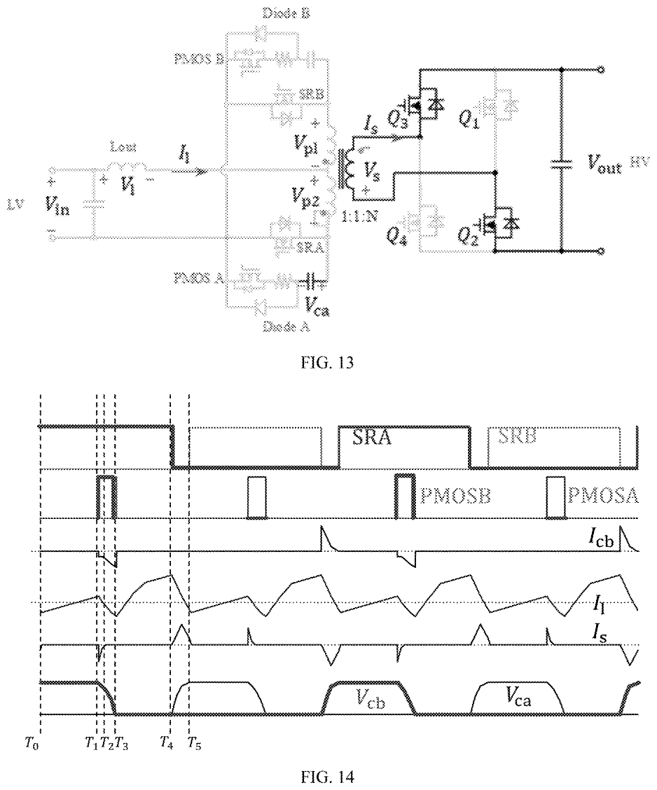

in the stage T4~T5: the first switching device SRA, the second switching device SRB, the first clamping switch PMOS A, the second clamping switch PMOS B, the first clamping diode Diode A and the second clamping diode Diode B are turned off; as shown in FIG. 13, the low-voltage side LV cannot transfer energy to the high-voltage side HV.

Therefore, in the soft start period, in the case that the synchronous rectification switch is operated at the duty cycle below 50% and the voltage Vₒᵤₜ of the high-voltage side is less than N*the voltage Vᵢₙ of the low-voltage side, when the synchronous rectification switch is turned on, the energy can be transferred to the high-voltage side HV; when the clamping switch is turned on, the energy stored in the clamping capacitance can also be released to the high-voltage side HV; furthermore, at the moment when the clamping switch is turned off, the clamping capacitor will be charged, and at this time, the energy can also be transferred to the high-voltage side HV.

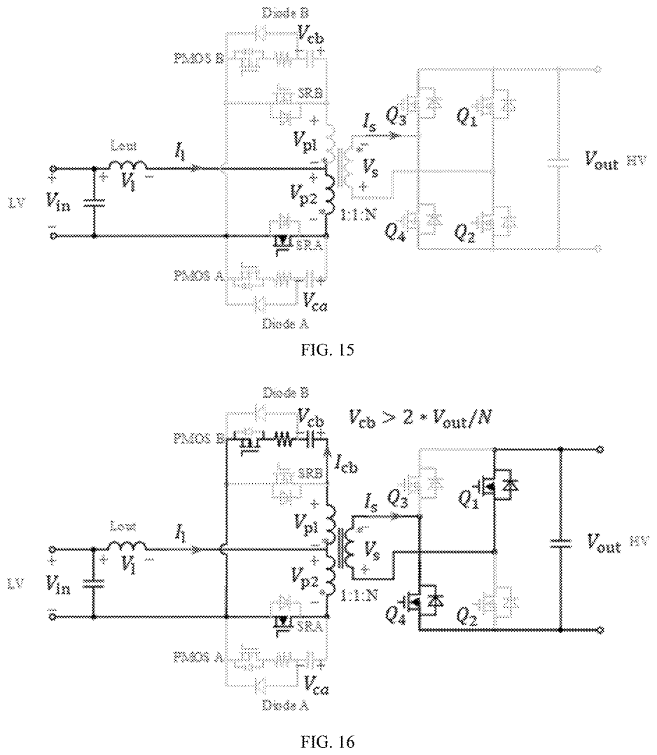

In the soft start period, the synchronous rectification switch is operated at the duty cycle below 50%. If the voltage Vₒᵤₜ of the high-voltage side is greater than N*the voltage Vᵢₙ of the low-voltage side, and the operation timing of the DCDC converter is as shown in FIG. 14:
in the stage T0~T1: the first switching device SRA is turned on; the second switching device SRB, the first clamping switch PMOS A, the second clamping switch PMOS B, the first clamping diode Diode A and the second clamping diode Diode B are turned off, and the respective switches in the inverter module 101 are turned off; as shown in FIG. 15, at this time:

$${V}_{1} = {V}_{in} - {V}_{p 2} > 0 ;$$

in the stage T1~T2: the first switching device SRA and the second clamping switch PMOS B are turned on; the second switching device SRB, the first clamping switch PMOS A, the first clamping diode Diode A and the second clamping diode Diode B are turned off; as shown in FIG. 16, at this time:

$${V}_{1} = {V}_{in} - {V}_{p 2} < 0$$

$${V}_{p 1} = {V}_{p 2} = {V}_{s} / N$$

$${V}_{s} = {V}_{out} ;$$

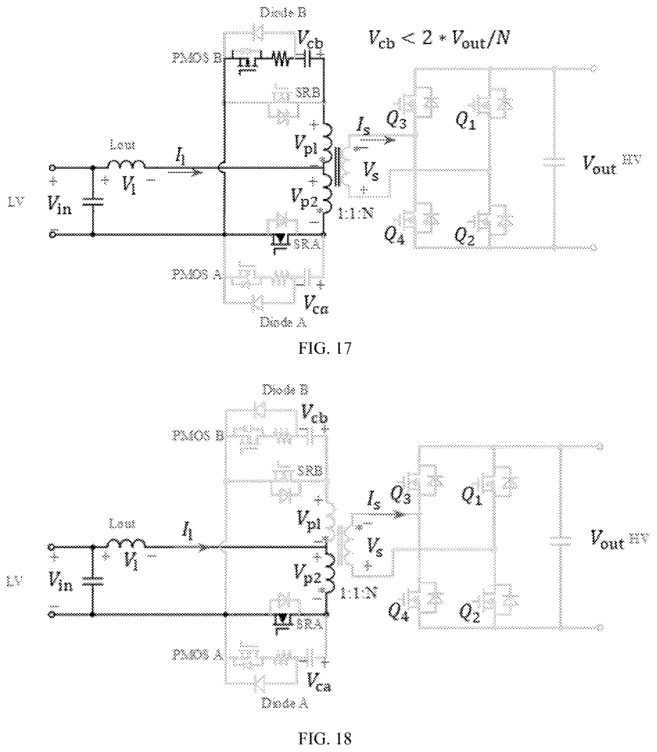

in the stage T2~T3: the first switching device SRA and the second clamping switch PMOS B are turned on; the second switching device SRB, the first clamping switch PMOS A, the first clamping diode Diode A and the second clamping diode Diode B are turned off, and the respective switches in the inverter module 101 are turned off; as shown in FIG. 17, at this time:

$${V}_{1} = {V}_{in} - {V}_{p 2} < 0 ;$$

in the stage T3~T4: the first switching device SRA is turned on; the second switching device SRB, the first clamping switch PMOS A, the second clamping switch PMOS B, the first clamping diode Diode A and the second clamping diode Diode B are turned off, and the respective switches in the inverter module 101 are turned off; as shown in FIG. 18, at this time:

$${V}_{1} = {V}_{in} - {V}_{p 2} > 0 ;$$

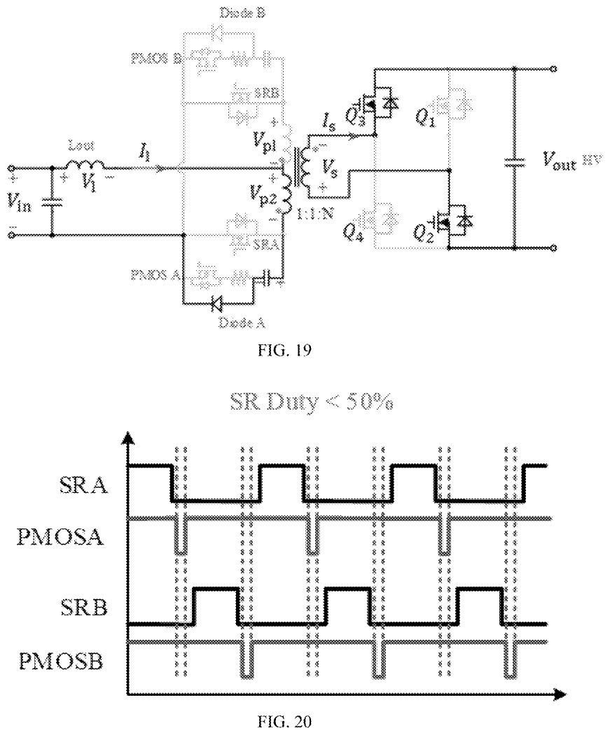

in the stage T4~T5: the first clamping diode Diode A is turned on; the first switching device SRA, the second switching device SRB, the first clamping switch PMOS A, the second clamping switch PMOS B and the second clamping diode Diode B are turned off as shown in FIG. 19, at this time:

$${V}_{1} = {V}_{in} - {V}_{p 2} - {V}_{ca} < 0$$

$${V}_{p 1} = {V}_{p 2} = {V}_{s} / N$$

$${V}_{s} = - {V}_{out} .$$

Therefore, in the soft start period, in the case that the synchronous rectification switch is operated at the duty cycle below 50% and the voltage Vₒᵤₜ of the high-voltage side is greater than N*the voltage Vᵢₙ of the low-voltage side, when the synchronous rectification switch is turned on, the energy of the low-voltage side LV cannot be transferred to the high-voltage side HV since the voltage Vₚ₂ of the second sub-winding is lower than the voltage Vₒᵤₜ of the high-voltage side; when the clamping switch is turned on, a portion of the energy can be transferred to the high-voltage side HV at this time since the voltage of the clamping capacitor is higher than the voltage Vₚ₂ of the second sub-winding, and as the voltage of the clamping capacitor is decreased, no more energy is transferred to the high-voltage side HV; when the clamping switch is turned off, similarly, a portion of the energy will be transferred to the high-voltage side HV. The presence of the clamping circuit can achieve boost when the synchronous rectification switch is operated at the duty cycle below 50%.

It can be understood that in the soft start period, in the case that the synchronous rectification switch is operated at the duty cycle below 50%, the active clamping circuit can be used to absorb energy from the first inductor Lout and transfer a portion of the energy to the second winding when the clamping switch is turned on.

The applicant has also found, after research, that in the case that the synchronous rectification switch is operated at the duty cycle below 50%, if the on-time of the clamping switch is too long, it will lead to over discharge of the clamping capacitor, resulting in damage to the clamping resistor; if the moment of turning on the clamping switch is unreasonable, the clamping capacitor will not be able to be fully discharged, which will lead to excessive stress on the synchronous rectification switch and less energy transferred to the high-voltage side HV, thereby the voltage of the high-voltage side HV rises slower.

Therefore, it is particularly important to control the on-time of the clamping switch reasonably.

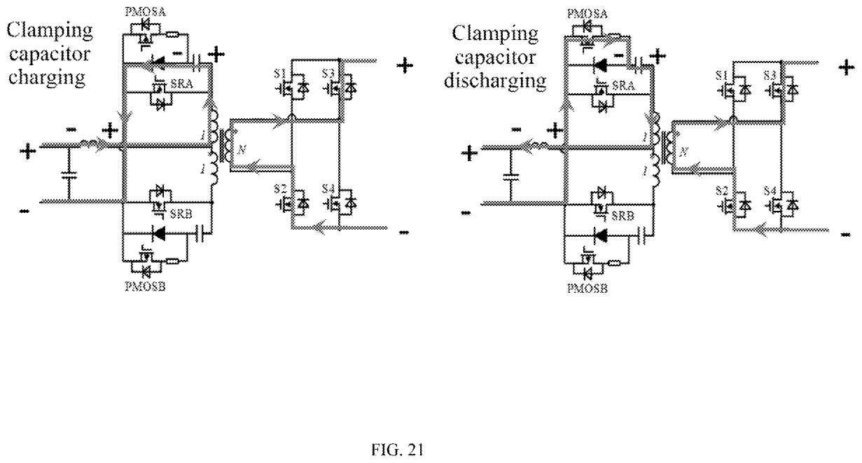

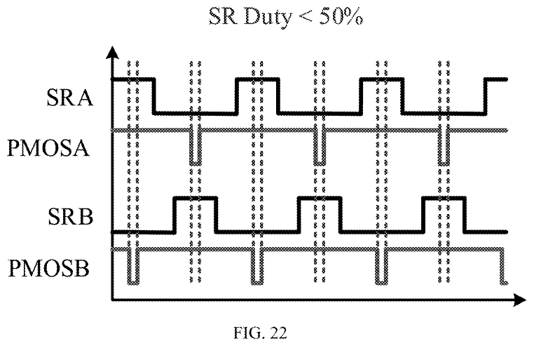

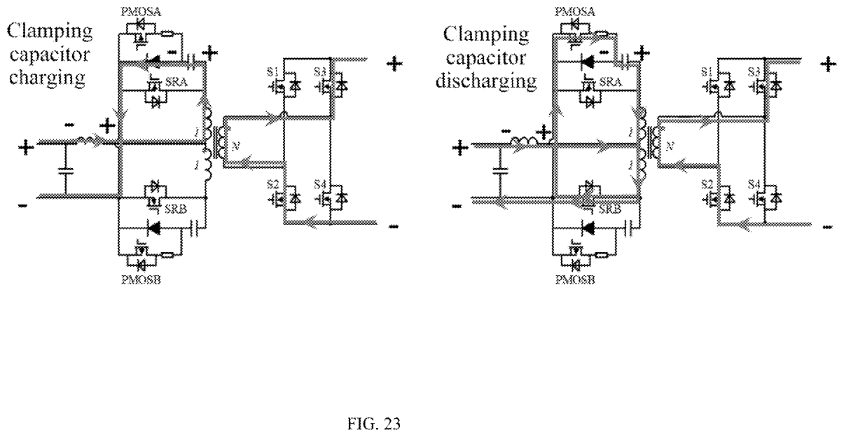

Based on that, the applicant has conducted a research on the moment of turning on the clamping switch. In the soft start period and in the case that the synchronous rectification switch is operated at the duty cycle below 50%, the clamping switch is controlled to turn on immediately after the synchronous rectification switch is turned off, as shown in FIG. 20. Correspondingly, charging and discharging paths of the clamping capacitor are shown in FIG. 21. The clamping switch is controlled to start to turn on at the midpoint moment of the off-period of the synchronous rectification switch, as shown in FIG. 22. Correspondingly, charging and discharging paths of the clamping capacitor are shown in FIG. 23.

As shown in FIG. 21 and FIG. 23, if the clamping switch is controlled to turn on immediately after the synchronous rectification switch is turned off, the clamping capacitor discharges less after being charged, resulting in a greater voltage increase of the clamping capacitor, thereby leading to a higher stress on the synchronous rectification switch; if the clamping switch is controlled to start to turn on at the midpoint moment of the off-period of the synchronous rectification switch, the clamping capacitor discharges more after being charged, so that the stress on the synchronous rectification switch is relatively low.

The applicant has also researched the steady state of the DCDC converter, after which it is found that in the steady state, if the synchronous rectification switch is operated at the duty cycle below 50%, the operation mode of the DCDC converter is similar to that in the soft start period when the synchronous rectification switch is operated at the duty cycle below 50% and the voltage Vₒᵤₜ of the high-voltage side is greater than N*the voltage Vᵢₙ of the low-voltage side, which will not be described here.

Next, it is mainly explained that the synchronous rectification switch is operated at the duty cycle of 50% and above in the steady state. Considering different loads connected to the DCDC converter, the current of the first inductor Lout corresponds to different modes. Therefore, situations of different loads will be explained.

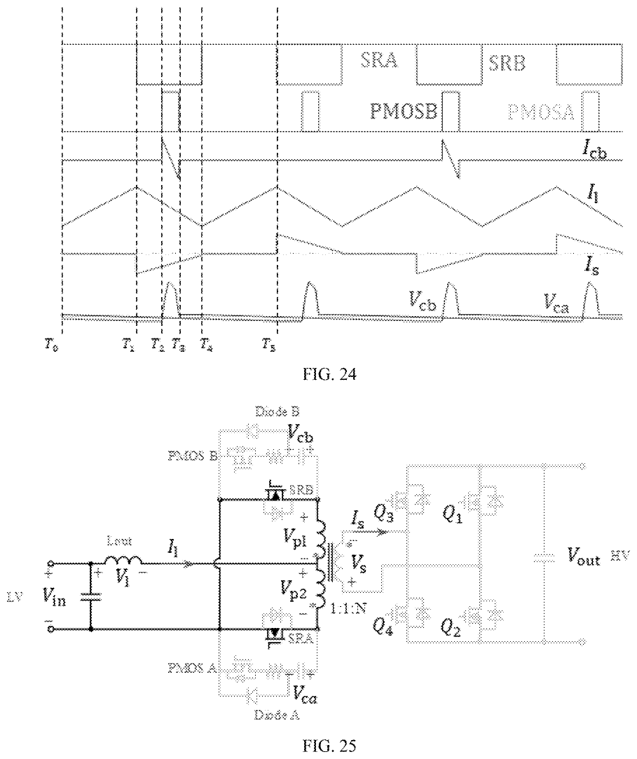

As shown in FIG. 24, when the load is heavy, the current of the first inductor Lout corresponds to a continuous conduction mode (CCM), and the continuous conduction mode is an operation mode in which the current of the first inductor Lout remains greater than zero throughout a switching cycle.

Specifically, in the stage T0~T1: the first switching device SRA and the second switching device SRB are turned on; the first clamping switch PMOS A, the second clamping switch PMOS B, the first clamping diode Diode A and the second clamping diode Diode B are turned off, and the respective switches in the inverter module 101 are turned off; as shown in FIG. 25, at this time:

$${V}_{1} = {V}_{in}$$

$${V}_{p 1} = {V}_{p 2} = 0 ;$$

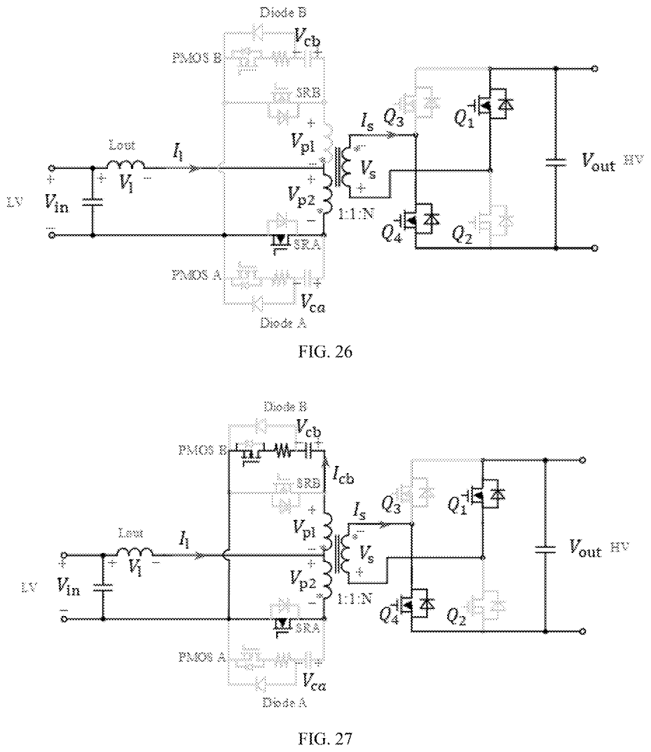

in the stage T1~T2: the first switching device SRA is turned on; the second switching device SRB, the first clamping switch PMOS A, the second clamping switch PMOS B, the first clamping diode Diode A and the second clamping diode Diode B are turned off; as shown in FIG. 26, at this time:

$${V}_{1} = {V}_{in} - {V}_{p 2} < 0$$

$${V}_{p 1} = {V}_{p 2} = {V}_{s} / N$$

$${V}_{s} = {V}_{out} ;$$

in the stage T2~T3: the first switching device SRA and the second clamping switch PMOS B are turned on; the second switching device SRB, the first clamping switch PMOS A, the first clamping diode Diode A and the second clamping diode Diode B are turned off; as shown in FIG. 27, at this time:

$${V}_{1} = {V}_{in} - {V}_{p 2} < 0$$

$${V}_{p 1} = {V}_{p 2} = {V}_{s} / N$$

$${V}_{s} = {V}_{out} ;$$

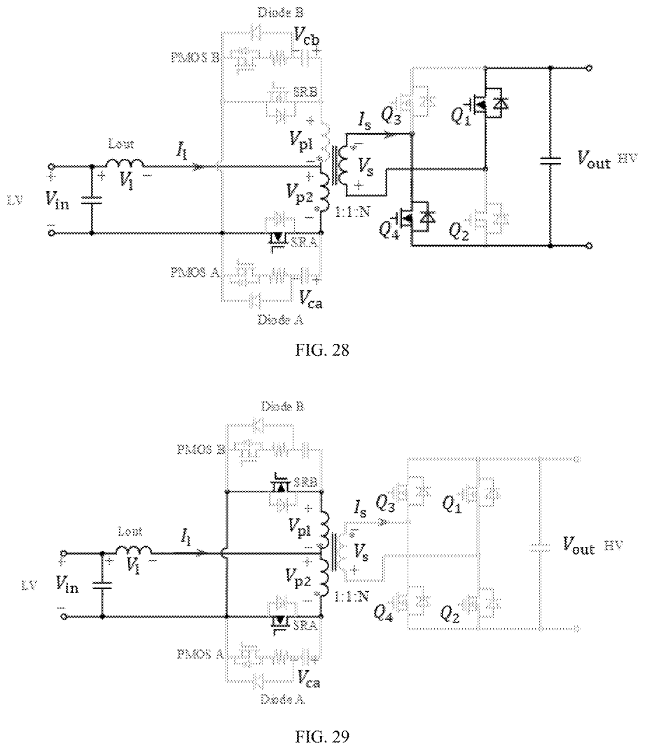

in the stage T3~T4: the first switching device SRA is turned on; the second switching device SRB, the first clamping switch PMOS A, the second clamping switch PMOS B, the first clamping diode Diode A and the second clamping diode Diode B are turned off; as shown in FIG. 28, at this time:

$${V}_{1} = {V}_{in} - {V}_{p 2} < 0$$

$${V}_{p 1} = {V}_{p 2} = {V}_{s} / N$$

$${V}_{s} = {V}_{out} ;$$

in the stage T4~T5: the first switching device SRA and the second switching device SRB are turned on; the first clamping switch PMOS A, the second clamping switch PMOS B, the first clamping diode Diode A and the second clamping diode Diode B are turned off; as shown in FIG. 29, at this time:

$${V}_{1} = {V}_{in}$$

$${V}_{p 1} = {V}_{p 2} = 0 .$$

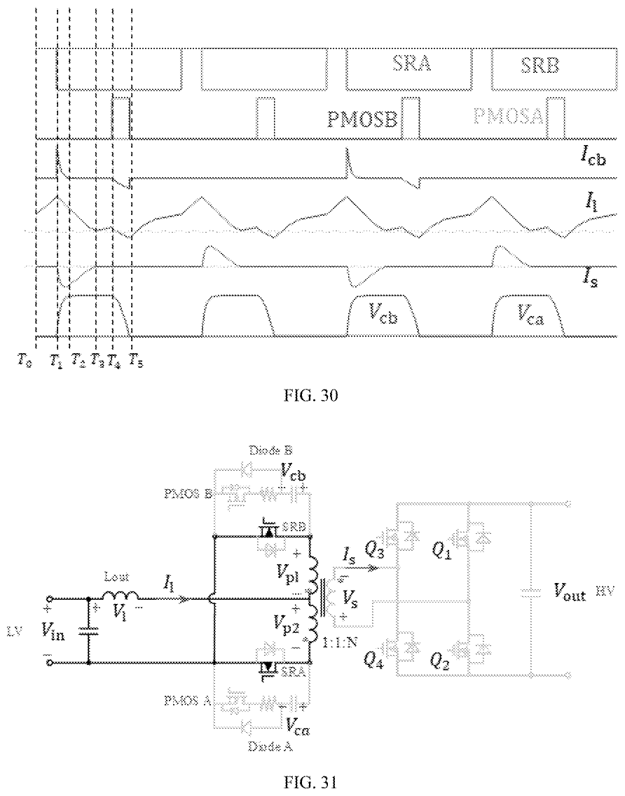

As shown in FIG. 30, when the load is light, the current of the first inductor Lout corresponds to a discontinuous conduction mode (DCM), and the discontinuous conduction mode is an operation mode in which the current of the first inductor Lout drops to zero within each switching cycle.

Specifically, in the stage T0~T1: the first switching device SRA and the second switching device SRB are turned on; the first clamping switch PMOS A, the second clamping switch PMOS B, the first clamping diode Diode A and the second clamping diode Diode B are turned off, and the respective switches in the inverter module 101 are turned off; as shown in FIG. 31, at this time:

$${V}_{1} = {V}_{in}$$

$${V}_{p 1} = {V}_{p 2} = 0 ;$$

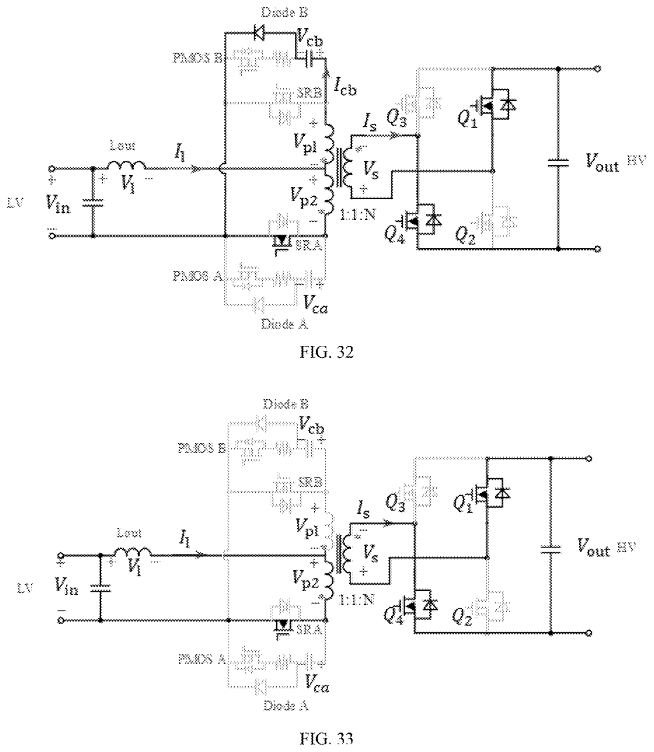

in the stage T1~T2: the first switching device SRA and the second clamping diode Diode B are turned on; the second switching device SRB, the first clamping switch PMOS A, the second clamping switch PMOS B and the first clamping diode Diode A are turned off; as shown in FIG. 32, at this time:

$${V}_{1} = {V}_{in} - {V}_{p 2} < 0$$

$${V}_{p 1} = {V}_{p 2} = {V}_{s} / N$$

$${V}_{s} = {V}_{out} ;$$

in the stage T2~T3: the first switching device SRA is turned on; the second switching device SRB, the first clamping switch PMOS A, the second clamping switch PMOS B, the first clamping diode Diode A and the second clamping diode Diode B are turned off; as shown in FIG. 33, at this time:

$${V}_{1} = {V}_{in} - {V}_{p 2} < 0$$

$${V}_{p 1} = {V}_{p 2} = {V}_{s} / N$$

$${V}_{s} = {V}_{out} ;$$

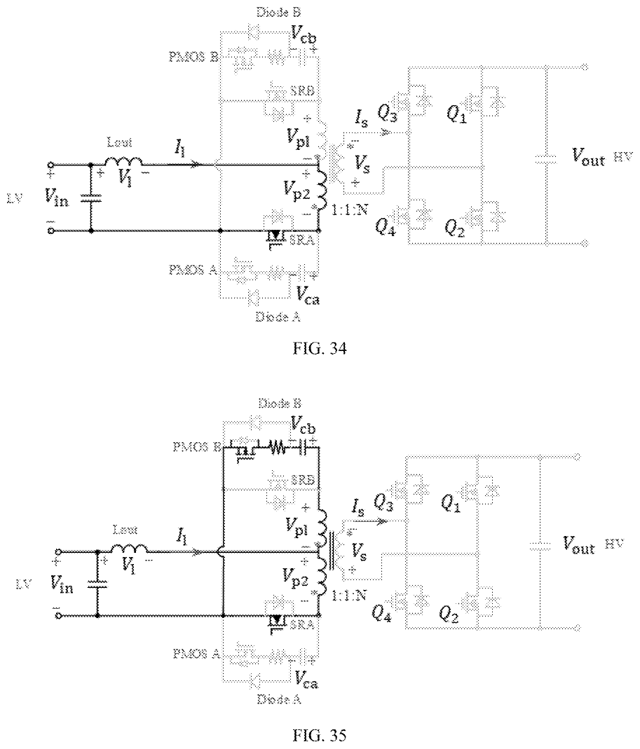

in the stage T3~T4: the first switching device SRA is turned on; the second switching device SRB, the first clamping switch PMOS A, the second clamping switch PMOS B, the first clamping diode Diode A and the second clamping diode Diode B are turned off, and the respective switches in the inverter module 101 are turned off; as shown in FIG. 34, at this time:

$${V}_{1} = {V}_{in} - {V}_{p 2} > 0 ;$$

in the stage T4~T5: the first switching device SRA and the second clamping switch PMOS B are turned on; the second switching device SRB, the first clamping switch PMOS A, the first clamping diode Diode A and the second clamping diode Diode B are turned off; as shown in FIG. 35, at this time:

$${V}_{1} = {V}_{in}$$

$${V}_{p 1} = {V}_{p 2} = 0 .$$

It can be understood that when the load is light, in the stage T4~T5, the second clamping switch PMOS B is turned on, and the current of the first inductor Lout drops to zero. The energy in the first inductor Lout has been completely released, and the voltage of the second winding is no longer clamped by the voltage of the low-voltage side LV multiplied by the turn ratio (N*Vᵢₙ), which results in the over discharge of the clamping capacitor.

Therefore, the clamping switch is turned on immediately when the corresponding synchronous rectification switch is turned off, and the first inductor Lout just enters a freewheeling stage, so the situation of the over discharge of the clamping capacitor will not occur. This is also shown by the following experimental results.

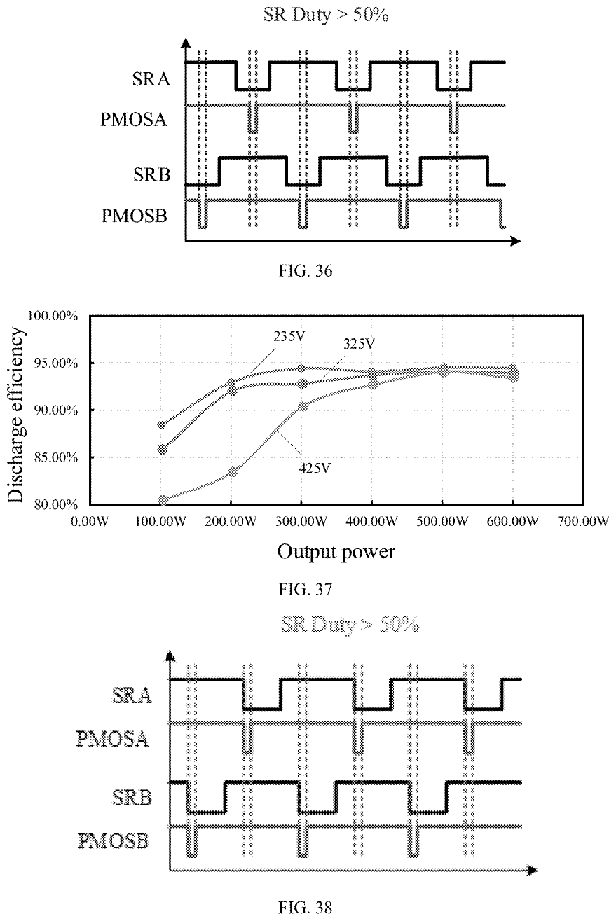

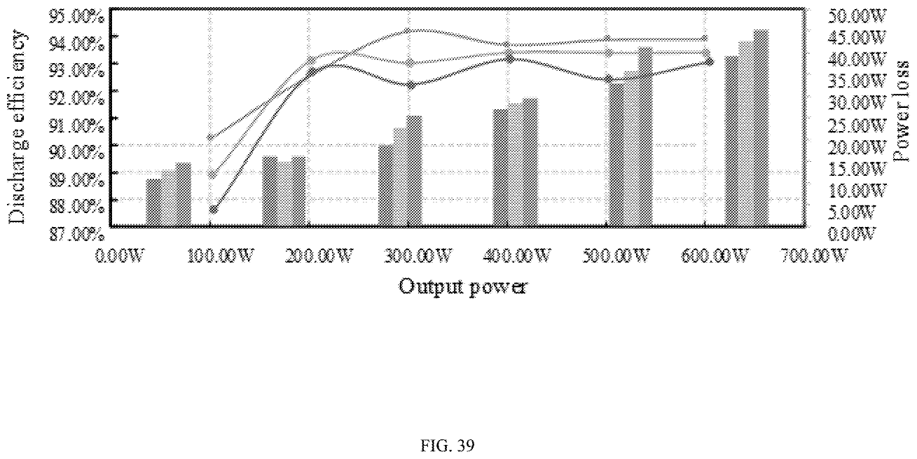

In a case of controlling the clamping switch with the timing as shown in FIG. 36 (the clamping switch starts to turn on at the midpoint moment of the off-period of the synchronous rectification switch), the discharge efficiency at 25° C. water temperature, 16V input (the voltage of the low-voltage side) and 235V/325V/425V output (the voltage of the high-voltage side) is as shown in FIG. 37. In a case of controlling the clamping switch with the timing as shown in FIG. 38 (the clamping switch is turned on immediately after the synchronous rectification switch is turned off), the discharge efficiency at 25° C. water temperature, 16V input (the voltage of the low-voltage side) and 235V/325V/425V output (the voltage of the high-voltage side) is as shown in FIG. 39.

In combination with FIG. 37 and FIG. 39, for the clamping switch being turned on immediately at the moment when the corresponding synchronous rectification switch is turned off, the discharge efficiency is significantly improved, the situation of the over discharge of the clamping capacitor is reduced, and the power loss of the clamping resistor is greatly reduced.

Based on the above, it can be learned that controlling the moment of turning on the clamping switch is particularly important, both in the soft start period and in the steady state, and whether the synchronous rectification switch is operated at the duty cycle below 50%, or operated at the duty cycle of 50% and above.

In view of this, the present application proposes a DCDC converter control method. After determining a control signal of a synchronous rectification switch, on-time of a clamping switch is controlled based on the control signal of the synchronous rectification switch, so that reverse pre-charging of the DCDC converter can be achieved through an active clamping circuit.

The technical solutions of the present application and how the technical solutions of the present application solve the above technical problems are described in detail below with the specific embodiments. The following specific embodiments may be combined with each other, and the same or similar concepts or processes may not be repeated in certain embodiments. Embodiments of the present application will be described below in conjunction with the accompanying drawings.

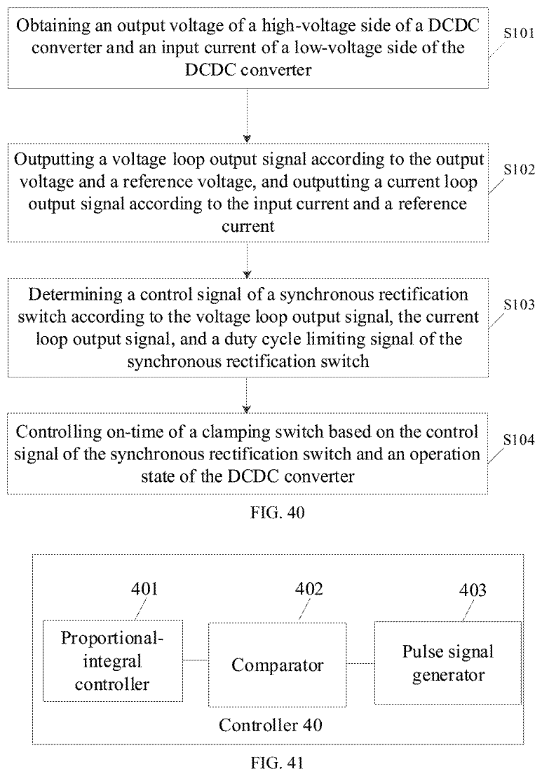

FIG. 40 is a schematic flowchart of a DCDC converter control method provided in the present application. As shown in FIG. 40, the method includes the following steps.

S101, obtaining an output voltage of a high-voltage side of a DCDC converter and an input current of a low-voltage side of the DCDC converter.

S102, outputting a voltage loop output signal according to the output voltage and a reference voltage, and outputting a current loop output signal according to the input current and a reference current.

Here, the voltage loop output signal is used to maintain the stability of the output voltage of the high-voltage side, and the current loop output signal is used to limit the input current of the low-voltage side and reduce the impact on a low-voltage battery.

Exemplarily, the voltage loop output signal can be determined by a PI (proportional-integral) controller according to the output voltage of the high-voltage side and the reference voltage. The PI controller can calculate an error between the output voltage and the reference voltage. The proportional portion is adjusted according to the error, and the integral portion is adjusted according to an accumulation of the error over time. The PI controller sums the results of the proportional portion and the integral portion to generate the voltage loop output signal. The voltage loop output signal can be used to adjust a duty cycle or on-time of a synchronous rectification switch to make the output voltage of the high-voltage side close to the reference voltage. Similarly, the current loop output signal can be outputted by the PI controller according to the input current and the reference current.

S103, determining a control signal of a synchronous rectification switch according to the voltage loop output signal, the current loop output signal, and a duty cycle limiting signal of the synchronous rectification switch.

Here, the duty cycle limiting signal of the synchronous rectification switch is used to limit the maximum duty cycle of the synchronous rectification switch to ensure that the synchronous rectification switch will not start up with a large duty cycle.

In some embodiments, as shown in FIG. 41, when the DCDC converter is in a soft start period, the duty cycle limiting signal is gradually increased with time, and when the DCDC converter is in a steady state, a value of the duty cycle limiting signal is a set value, where the set value may be determined according to an actual situation. In the soft start period, the duty cycle limiting signal is controlled to increase gradually, then the output voltage of the high-voltage side is also increased gradually, which effectively limits an inrush current during start up and protects the power supply and the load. In the steady state, the duty cycle limiting signal is controlled to the set value; at this time the DCDC converter reaches a normal operation state, and the output voltage of the high-voltage side is stabilized close to the reference voltage.

In some embodiments, a minimum value of the voltage loop output signal, the current loop output signal and the duty cycle limiting signal is obtained, and the minimum value is taken as the control signal of the synchronous rectification switch. The voltage loop output signal is responsible for maintaining the stability of the output voltage, the current loop output signal is responsible for limiting the maximum value of the current, and the duty cycle limiting signal is used for preventing the duty cycle from being too large. The selection of the minimum value can ensure that no overshoot occurs under any circumstances.

In some examples, the synchronous rectification switch includes a first switching device and a second switching device, and a phase of a control signal of the first switching device and a phase of a control signal of the second switching device differ by 180°. By the 180° phase difference of the control signals of the two switching devices, full-wave rectification can be realized, that is, within each switching cycle, the current can flow in two directions, thereby improving the power transmission efficiency.

S104, controlling on-time of a clamping switch based on the control signal of the synchronous rectification switch and an operation state of the DCDC converter.

In some embodiments, an operation mode of the clamping switch is determined based on the control signal of the synchronous rectification switch and the operation state of the DCDC converter, and the on-time of the clamping switch is then controlled according to the operation mode of the clamping switch.

Exemplarily, the operation mode of the clamping switch is determined in advance to include a first mode, a second mode, a third mode and a fourth mode, according to the control signal of the synchronous rectification switch and the operation state of the DCDC converter.

In some examples, when the control signal of the synchronous rectification switch is greater than a preset value and the DCDC converter is in the soft start period, the operation mode of the clamping switch is determined to be the first mode. Then, according to the first mode, the clamping switch can be controlled to turn on when the synchronous rectification switch is turned off, and the on-duration is a first duration, so as to prevent the over discharge of the clamping capacitor and reduce the damage to the clamping resistor and the clamping diode.

Exemplarily, the preset value can be determined according to an actual situation and may be, for example, 50%. The first duration can be determined according to an actual situation and may be, for example, 0.2 μs.

For example, when the duty cycle of the first switching device and the second switching device is greater than 50% and the phase difference between the first clamping switch and the second clamping switch is 180°, if the DCDC converter is in the soft start period, the first clamping switch is turned on for 0.2 μs immediately after the first switching device is turned off and the second clamping switch is turned on for 0.2 μs immediately after the second switching device is turned off.

In some examples, when the control signal of the synchronous rectification switch is greater than a preset value and the DCDC converter is in the steady state, the operation mode of the clamping switch is determined to be the second mode. Then, according to the second mode, the clamping switch can be controlled to turn on when the synchronous rectification switch is turned off, and the on-duration is a second duration, so as to prevent the over discharge of the clamping capacitor and reduce the damage to the clamping resistor and the clamping diode.

Exemplarily, the second duration can be determined according to an actual situation and may be, for example, 0.3 μs.

For example, when the duty cycle of the first switching device and the second switching device is greater than 50% and the phase difference between the first clamping switch and the second clamping switch is 180°, if the DCDC converter is in the steady state, the first clamping switch is turned on for 0.3 μs immediately after the first switching device is turned off and the second clamping switch is turned on for 0.3 μs immediately after the second switching device is turned off.

In some examples, when the control signal of the synchronous rectification switch is less than or equal to the preset value and the DCDC converter is in the soft start period, the operation mode of the clamping switch is determined to be the third mode. Then, according to the third mode, the clamping switch can be controlled to turn on when the synchronous rectification switch is turned on, and the on-duration is a third duration. The clamping switch and the corresponding synchronous rectification switch are turned on for a certain time simultaneously, to ensure that the clamping capacitor can be fully discharged in the soft start period, reduce the voltage stress on the synchronous rectification switch, and at the same time enable the output voltage of the high-voltage side to be rapidly increased.

Exemplarily, the third duration can be determined according to an actual situation and may be, for example, 1.5 μs.

For example, when the duty cycle of the first switching device and the second switching device is less than or equal to 50% and the phase difference between the first clamping switch and the second clamping switch is 180°, if the DCDC converter is in the soft start period, the first clamping switch is turned on for 1.5 μs during the period of the first switching device being turned on and the second clamping switch is turned on for 1.5 μs during the period of the second switching device being turned on.

In some examples, when the control signal of the synchronous rectification switch is less than or equal to the preset value and the DCDC converter is in the steady state, the operation mode of the clamping switch is determined to be the fourth mode. Then, according to the fourth mode, the clamping switch can be controlled to turn on immediately when the synchronous rectification switch is turned off, and the on-duration is a fourth duration, so as to prevent the over discharge of the clamping capacitor and reduce the damage to the clamping resistor and the clamping diode.

Exemplarily, the fourth duration can be determined according to an actual situation and may be, for example, 0.6 μs.

For example, when the duty cycle of the first switching device and the second switching device is less than or equal to 50% and the phase difference between the first clamping switch and the second clamping switch is 180°, if the DCDC converter is in the steady state, the first clamping switch is turned on for 0.6 μs immediately after the first switching device is turned off and the second clamping switch is turned on for 0.6 μs immediately after the second switching device is turned off.

In practical applications, after the control signal of the synchronous rectification switch is determined, it is determined whether the control signal of the synchronous rectification switch is greater than the preset value; in a case where it is determined that the control signal of the synchronous rectification switch is greater than the preset value, it is determined whether the operation mode of the DCDC converter is the soft start period, if so, the operation mode of the clamping switch is determined to be the first mode, and if not, the operation mode of the clamping switch is determined to be the second mode; in a case where it is determined that the control signal of the synchronous rectification switch is less than or equal to the preset value, it is determined whether the operation mode of the DCDC converter is the soft start period, if so, the operation mode of the clamping switch is determined to be the third mode, and if not, the operation mode of the clamping switch is determined to be the fourth mode.

The DCDC converter control method provided by the present application is described above, and embodiments of the present application also provide a controller. As shown in FIG. 41, a controller 40 provided by embodiments of the present application includes:
a proportional-integral controller 401, a comparator 402 and a pulse signal generator 403, where the comparator 402 is connected to the proportional-integral controller 401 and the pulse signal generator 403;
the proportional-integral controller 401 is configured to: output a voltage loop output signal according to the output voltage of a high-voltage side of a DCDC converter and a reference voltage, and output a current loop output signal according to the input current of a low-voltage side of the DCDC converter and a reference current;
the comparator 402 is configured to determine a control signal of a synchronous rectification switch in the DCDC converter according to the voltage loop output signal, the current loop output signal, and a duty cycle limiting signal of the synchronous rectification switch in the DCDC converter;
the pulse signal generator 403 is configured to control on-time of a clamping switch in the DCDC converter according to the control signal of the synchronous rectification switch and an operation state of the DCDC converter.

In some embodiments, the pulse signal generator 403 includes a generating module 4031 and a driving module 4032, and the generating module 4031 is connected to the driving module 4032. The generating module 4031 is configured to generate a driving signal of the clamping switch based on the control signal of the synchronous rectification switch and the operation state of the DCDC converter, such as a driving signal SRA PWM of a first clamping switch and a driving signal SRB PWM of a second clamping switch. The driving module 4032 is configured to control the on-time of the clamping switch according to the driving signal of the clamping switch.

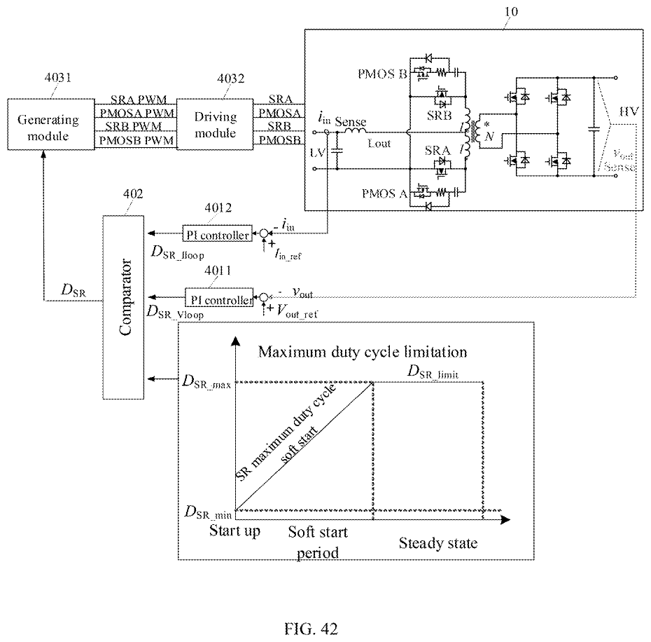

In some embodiments, as shown in FIG. 42, the proportional-integral controller 401 includes a PI controller 4011 and a PI controller 4012. The PI controller 4011 is configured to output a voltage loop output signal D_{SR_Vloop} according to an output voltage Vₒᵤₜ of the high-voltage side of the DCDC converter and a reference voltage V_{out_ref}. The PI controller 4012 is configured to output a current loop output signal D_{SR_Iloop} according to an input current Iᵢₙ of the low-voltage side of the DCDC converter and a reference current I_{in_ref}.

Embodiments of the present application also provide a control device, as shown in FIG. 42, including: the controller as described above and a DCDC converter 10. The DCDC converter 10 includes a synchronous rectification switch and a clamping switch. The controller is configured to control on-time of the clamping switch based on a control signal of the synchronous rectification switch and an operation state of the DCDC converter 10.

The present application also provides a computer program product, including a computer program, and when the computer program is executed by a processor, the method described above is implemented.

The present application also provides a computer-readable storage medium. The computer-readable storage medium stores computer instructions therein, and when the computer instructions are executed by a processor, the method described above is implemented.

Finally, it should be noted that other embodiments of the present application will readily come to mind to those skilled in the art upon consideration of the specification and practice of the present application disclosed herein. The present application is intended to cover any variations, uses or adaptations of the present application. These variations, uses or adaptations follow the general principles of the present application and include common knowledge or conventional technical means in the art not disclosed herein, and they are not limited to the precise structures that have been described above and illustrated in the accompanying drawings, and may be subjected to various modifications and alterations without departing from the scope thereof. The scope of the present application is limited only by the appended claims.

What is claimed is:

1. A direct current-direct current (DCDC) converter control method, wherein a DCDC converter comprises a synchronous rectification switch and a clamping switch, and the method comprises:
obtaining an output voltage of a high-voltage side of the DCDC converter and an input current of a low-voltage side of the DCDC converter;
outputting a voltage loop output signal according to the output voltage and a reference voltage, and outputting a current loop output signal according to the input current and a reference current;
determining a control signal of the synchronous rectification switch according to the voltage loop output signal, the current loop output signal, and a duty cycle limiting signal of the synchronous rectification switch; and
controlling on-time of the clamping switch based on the control signal of the synchronous rectification switch and an operation state of the DCDC converter.

2. The method according to claim 1, wherein the controlling the on-time of the clamping switch based on the control signal of the synchronous rectification switch and the operation state of the DCDC converter comprises:
determining an operation mode of the clamping switch based on the control signal of the synchronous rectification switch and the operation state of the DCDC converter; and
controlling the on-time of the clamping switch according to the operation mode of the clamping switch.

3. The method according to claim 2, wherein the determining the operation mode of the clamping switch based on the control signal of the synchronous rectification switch and the operation state of the DCDC converter comprises:
when the control signal of the synchronous rectification switch is greater than a preset value and the DCDC converter is in a soft start period, determining the operation mode of the clamping switch to be a first mode;
wherein the controlling the on-time of the clamping switch according to the operation mode of the clamping switch comprises:
controlling, according to the first mode, the clamping switch to turn on when the synchronous rectification switch is turned off, with an on-duration being a first duration.

4. The method according to claim 2, wherein the determining the operation mode of the clamping switch based on the control signal of the synchronous rectification switch and the operation state of the DCDC converter comprises:
when the control signal of the synchronous rectification switch is greater than a preset value and the DCDC converter is in a steady state, determining the operation mode of the clamping switch to be a second mode;
wherein the controlling the on-time of the clamping switch according to the operation mode of the clamping switch comprises:
controlling, according to the second mode, the clamping switch to turn on when the synchronous rectification switch is turned off, with an on-duration being a second duration.

5. The method according to claim 2, wherein the determining the operation mode of the clamping switch based on the control signal of the synchronous rectification switch and the operation state of the DCDC converter comprises:
when the control signal of the synchronous rectification switch is less than or equal to a preset value and the DCDC converter is in a soft start period, determining the operation mode of the clamping switch to be a third mode;
wherein the controlling the on-time of the clamping switch according to the operation mode of the clamping switch comprises:
controlling, according to the third mode, the clamping switch to turn on when the synchronous rectification switch is turned on, with an on-duration being a third duration.

6. The method according to claim 2, wherein the determining the operation mode of the clamping switch based on the control signal of the synchronous rectification switch and the operation state of the DCDC converter comprises:
when the control signal of the synchronous rectification switch is less than or equal to a preset value and the DCDC converter is in a steady state, determining the operation mode of the clamping switch to be a fourth mode;
wherein the controlling the on-time of the clamping switch according to the operation mode of the clamping switch comprises:
controlling, according to the fourth mode, the clamping switch to turn on immediately when the synchronous rectification switch is turned off, with an on-duration being a fourth duration.

7. The method according to claim 1, wherein the synchronous rectification switch comprises a first switching device and a second switching device, and a phase of a control signal of the first switching device and a phase of a control signal of the second switching device differ by 180°.

8. The method according to claim 1, wherein the determining the control signal of the synchronous rectification switch according to the voltage loop output signal, the current loop output signal, and the duty cycle limiting signal of the synchronous rectification switch comprises:
obtaining a minimum value of the voltage loop output signal, the current loop output signal and the duty cycle limiting signal;
taking the minimum value as the control signal of the synchronous rectification switch.

9. The method according to claim 1, wherein when the DCDC converter is in a soft start period, the duty cycle limiting signal is gradually increased with time, and when the DCDC converter is in a steady state, a value of the duty cycle limiting signal is a set value.

10. A controller, comprising: a proportional-integral controller, a comparator, and a pulse signal generator, wherein the comparator is connected to the proportional-integral controller and the pulse signal generator;
the proportional-integral controller is configured to: output a voltage loop output signal according to an output voltage of a high-voltage side of a direct current-direct current (DCDC) converter and a reference voltage, and output a current loop output signal according to an input current of a low-voltage side of the DCDC converter and a reference current;
the comparator is configured to determine a control signal of a synchronous rectification switch in the DCDC converter according to the voltage loop output signal, the current loop output signal, and a duty cycle limiting signal of the synchronous rectification switch in the DCDC converter;
the pulse signal generator is configured to control on-time of a clamping switch in the DCDC converter based on the control signal of the synchronous rectification switch and an operation state of the DCDC converter.

11. The controller according to claim 10, wherein the pulse signal generator comprises a generating module and a driving module, and the generating module is connected to the driving module;
the generating module is configured to generate a driving signal of the clamping switch based on the control signal of the synchronous rectification switch and the operation state of the DCDC converter;
the driving module is configured to control the on-time of the clamping switch according to the driving signal of the clamping switch.

12. A control device, comprising: the controller according to claim 10 and a direct current-direct current (DCDC) converter, wherein the DCDC converter comprises a synchronous rectification switch and a clamping switch;
the controller is configured to control on-time of the clamping switch based on a control signal of the synchronous rectification switch and an operation state of the DCDC converter.

13. A non-transitory computer-readable storage medium, wherein the computer-readable storage medium storing computer instructions therein, and when the computer instructions are executed by a processor, causing the processor to execute the following:
obtaining an output voltage of a high-voltage side of a direct current-direct current (DCDC) converter and an input current of a low-voltage side of the DCDC converter;
outputting a voltage loop output signal according to the output voltage and a reference voltage, and outputting a current loop output signal according to the input current and a reference current;
determining a control signal of a synchronous rectification switch according to the voltage loop output signal, the current loop output signal, and a duty cycle limiting signal of the synchronous rectification switch; and
controlling on-time of a clamping switch based on the control signal of the synchronous rectification switch and an operation state of the DCDC converter.

14. A computer program product, wherein the computer program product comprises a non-transitory computer program, and when the computer program is executed by a processor, the method according to claim 1 is implemented.
